(19) United States
(12) Patent Application Publication
(10) Pub. No.: US 2002/0152117 A1
(43) Pub. Date: Oct. 17, 2002

(54) System and method for targeting object oriented audio and video content to users

(76) Inventors: Mike Cristofalo, Doylestown, PA (US); Frank Paul Deo, Kendall Park Middlesex, NJ (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 09/834,500

(22) Filed: Apr. 12, 2001

(51) Int. Cl. G06F 17/60

(52) U.S. Cl. 705/14

(57) ABSTRACT

A system and process for targeting programming (including, but not limited to, advertising) to users by utilizing media object to provide specific content to a user, or groups of users, based upon user profiling information is described. More specifically, the system and method provides for the generation of media object based content, formatting and transmitting the content, and receiving and presenting the content to a user based upon user profile information. The system includes a media object creator, which creates media objects utilized in a programming signal, a transmitting system for transmitting the media objects, a receiving system connected to a presentation device for receiving and presenting the media objects and a user profiling system which determines which media objects a user is to received based upon user profile information.

### FIELD OF THE INVENTION

The present invention relates to electronic information access systems and more specifically to a media object based system and method for targeting information to users based upon user profiles.

### BACKGROUND OF THE INVENTION

Television, radio, Internet, and other multimedia content creators and transmitters often rely upon mass market commercial advertising to sponsor programming presented to their viewers and listeners (for purposes of simplicity, those who receive programming in audio, video, textual, graphic, or other formats shall be referred to as “users”). Commonly, such advertising is provided as distinct audio and video segments which are presented during an interruption in a program the user has selected (for example, a Nike® commercial during a football game, a banner advertisement on an Internet page, or a logo on a video screen). While currently used advertising mechanisms have been marginally successful in promoting goods and services to non-participatory audiences (i.e., users who do not interact with the program and merely watch, listen, or read the presented content), such mechanisms leave a lot to be desired in today's multimedia, interactive environment. More specifically, such advertising mechanisms are often undesirable due to bandwidth considerations, transmission formats, and the fact that they do not facilitate the targeting of advertising and/or programming to users. As a result, much of the advertising and programming content currently provided is often misdirected, presented to a disinterested audience, or completely ignored by users.

Further compounding the task of garnering user interest in advertising and programming segments, is the fact that most of the programming currently being offered is provided on a national and/or regional basis. As a result many of the advertisements are also national/regional in scope and are not targeted to specific demographic groups or users matching specific user profiles. Often during the national/regional broadcasts, local affiliates attempt to focus their advertising slots and programming to the local audience by inserting locally generated commercials into the program, providing scrolling messages on the bottom of video displays (for example, severe weather warnings), and by other techniques. However, even the local affiliates are not specifically targeting advertising or programming to specific users. In short, the systems and processes currently available do not allow the advertisers, content creators (for both the advertisement and the underlying program), and/or transmitters to specifically tailor and target advertising and programming to specific users. As a result, much of today's commercial advertising and programming is ineffective, mis-targeted, and often totally ignored by users.

Various approaches have recently been proposed to address the inefficient use and targeting of advertising/programming, especially television and video based advertising. Commonly such approaches provide for the separation of a program (for example, a football game) into numerous 6 MHz analog channels, upon which unique commercial advertisements are inserted, with each channel providing different commercials. The user's system receives all of these channels and, according to user selections or a pre-set user profile, selects one of the channels for presenting the advertising and associated programming. As is readily appreciated by those skilled in the art, such an approach generally provides a limited number of programming signals into which the targeted advertising may be inserted (thus, minimizing the specificity of which such targeted advertising may be provided), while also requiring multiple signals to transmit the same underlying program and thus wasting precious bandwidth and transmission resources.

Additionally, those systems which attempt to target advertising to users generally rely upon user responses to questionnaires and other survey information and do not provide advertisers with sufficient, real-time information to tailor advertising to specific users. As such, a need exists for systems and processes, which provide efficient and effective targeted advertising/programming to users without requiring massive tradeoffs in bandwidth, transmission capacities, or other variables.

### SUMMARY OF THE INVENTION

The present invention provides a system and process for targeting programming (including, but not limited to, advertising) to users by utilizing media object to provide specific content to a user, or groups of users, based upon user profiling information. More specifically, the present invention provides a system and method for generating media object based content, formatting and transmitting the content, and receiving and presenting the content to a user. The media object based content is preferably presented to users based upon profile established for the user. As such, the systems and processes of the present invention enables media object content creators, producers, broadcasters, and others involved in the transmission of multimedia content to users to custom tailor such content for unique users and/or groups of users based upon user profiles.

The system utilizes user purchase behaviors, on-line activity, responses by a user to a survey, demographic information, user viewing habits, statistical information, regional information and other information to generate a user profile. The user profile may be generated at a receiving system, a transmitting system, or any other location (for example, by an internet service provider). Such profile information is utilized to identify user's based upon user profiles, create media objects for such profiles and present specific media objects to specific user profiles. As such, the present invention facilitates targeted advertising, targeted programming and other presentations to users. Instead of requiring all users to see a specific program, advertisement, game, show, or other presentation, the present invention facilitates the customization of each user's program based upon user profiles and the interchanging of one media object for another media object.

More specifically, in the preferred embodiment of the present invention, a transmitting system, a receiving system and a user profiling system are used to target content to users. The content is provided in the form of media objects, preferably using the MPEG-4 format, however, other formats may also be utilized, created by media object creators on a pre-recorded or live basis. The media objects are suitably communicated to the receiving system via any transmission medium, including broadcast, wireless, wireline, satellite, cable, fiber optics, microwave, and millimeter wave. Similarly, network connections may also be utilized to transmit the user profile information and/or the media objects to the user. Such network connections may utilize any known in the art including, the Internet, intranet, ATM network, private network, wireless network, wide area network, local area network, and a public network.

Further, user-profiling information is utilized by the receiving system and/or the transmitting system to determine which of a plurality of media objects to present to a specific user or group of users at any instance during a program, advertisement or other multi-media presentation. The media objects may be provided in any medium desired including, for example, audio, video, graphical, and textual. Further, such media objects may be provided by remote creators, via local storage mediums, via network broadcasts, cable systems, and other mediums to the user's receiving system. Similarly, the user profiling information may be local to the user or remote, for example, accessible by the media object creators and/or the transmitting system.

Further features and functions of the present invention will become apparent from a consideration of the following detailed description, drawing figures and claims.

### BRIEF DESCRIPTION OF THE DRAWING FIGURES

FIG. 1 is a schematic representation of a preferred embodiment of a system providing media object based content targeted to users based upon user profiles.

FIG. 2 is a schematic representation of the receiving system of FIG. 1 by which the media objects are received and selected for presentation to a user by the preferred embodiment.

FIG. 3 is an illustrative example of the receiving system of FIG. 2 for selecting one media object from a plurality of media objects provided in an automobile advertisement.

FIG. 4 is a flow chart illustrating the process by which the present invention may be utilized to push targeted advertising and programming to users via media objects selected based upon a user profile.

FIG. 5 is a flow chart illustrating the process by which the present invention may be utilized by a user to pull media objects, which are provided to the user based upon their user profile.

### DETAILED DESCRIPTION

The present invention provides a system and method for targeting audio and video content (for example, advertising and programming) to users by utilizing media objects and user responses thereto. Those skilled in the art of data transmission techniques and capabilities are familiar with the MPEG-4 (Motion Picture Expert Group) standard which has been promulgated in order to standardize the creation, transmission, distribution, and reception of media objects based upon audio, video, graphical and various other forms of data and information (hereafter, generically referred to as “content”). The present invention preferably utilizes the media object specifications of MPEG-4 and various other object based data transmission systems to generate user profiles, transmit content to users based upon such profiles, and thereby provide targeted advertising/programming, in the form of media objects, to such users. While the present invention is herein described with reference to the MPEG-4 standards, it is to be appreciated that various other systems and methods for transmitting and receiving media object based content may be utilized in conjunction with the present invention. Such systems include, for example, the Sony PlayStation®, which provides the capability of rendering graphical media objects over real-time video.

Additionally, throughout this specification, reference is made to media object oriented content, MPEG-4, and various other terms and standards promulgated by the MPEG. As used herein, “media objects” are defined in accordance with the definitions and descriptions provided in the “Overview of the MPEG-4 Standard” provided by the International Organization for Standardization, ISO/IEC JTC 1/SC29/WG11 N3156, December 1999/Maui, the contents of which are herein incorporated by reference. More specifically, “media objects” are commonly representations of aural, visual or audio-visual content which may be of natural or synthetic origin (i.e., a recording or a computer generated object). As is commonly known in the art, such media objects are commonly organized in a hierarchy with primitive objects (for example, still images, video objects, audio objects, etc.) and coded representations of objects (for example, text, graphics, synthetic heads, and synthetic sounds). These various objects are utilized to describe how the object is utilized in an audio, video, or audio-visual stream of data and allow each object to be represented independently of any other object and/or in reference to other objects. For example, a television commercial for an automobile may consist of an automobile, a scenery or route upon which the automobile travels, and an audio signal (for example, a voice describing the characteristics of the automobile, background sounds adding additional realism to the presentation, and background music). Each of these objects may be interchanged with another object (for example, a car for a truck, or a rock soundtrack for an easy listening soundtrack) without affecting the other objects, or specifically affecting the other objects—as desired by the content creator.

Additionally, throughout this application a “stream of data” (a.k.a., “streaming” or “streaming media”) is herein defined in accordance with the definition provided by Webopedia (www.webopedia.com) as “a technique for transferring data such that it can be processed as a steady and continuous stream . . . [such that] a client browser or plug-in can start displaying the data before the entire file has been transmitted.” Examples of technologies capable of supporting “streaming” include, but are not limited to, Progressive Network's RealAudio®, Real Network's Real Video®, Microsoft's NetShow®, and RTSP (Real Time Streaming Protocol). The present invention may utilize any of the various streaming technologies currently, or in the future, available as desired and/or as necessary to transmit media objects. Additionally, it is to be appreciated that non-streaming technologies may also be utilized in conjunction with the present invention including, for example, content presented via a compact disc or digital video disc, by completing a file transfer before beginning the presentation, or other transfer means.

Further, it is to be appreciated that the present invention may be utilized in a multicast environment, i.e., where the content/media objects are transmitted to a select group of users. Similarly, the present invention may be utilized in a unicast environment (i.e., where the content/media objects are transmitted to a single user) and/or a broadcast environment (i.e., where the content/media objects are transmitted to every user connected to a network, or, in the case of a radio frequency or satellite broadcast, to all users equipped with a proper receiving system).

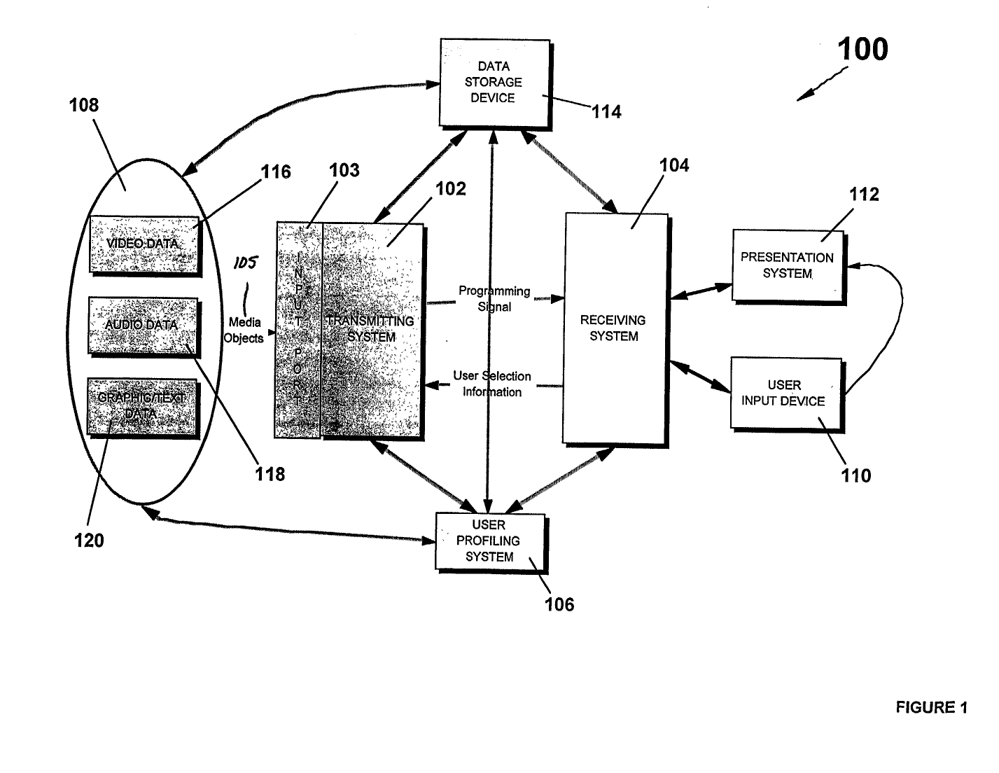

As shown in FIG. 1, one system 100 implementing the present invention includes three major elements: a transmitting system 102, a receiving system 104, and a user profiling system 106. Each of these three major elements is explained further in greater detail below. Additionally, the system 100 preferably includes media object creators 108, which create content in the form of media objects, which are utilized in the targeted advertising. The system 100 also preferably includes various ancillary devices such as user input devices 110, presentation systems 112, and data storage devices 114. The system 100 preferably includes all of those components and elements necessary to provide media object based targeted advertising. It is to be appreciated, however, that such components and elements may be utilized separately, in conjunction with existing content distribution systems, and/or as components of other systems without departing from the spirit or scope of the present invention.

Referring again to FIG. 1 and as mentioned previously, one of the major elements utilized in the preferred system 100 is the transmitting system 102. The transmitting system 102 may include any medium, system, or device capable of communicating media object oriented content to a user including, but not limited to: wireless transmission systems (for example, analog and digital television broadcasts, analog and digital radio broadcasts, analog and digital wireless communications networks, microwave systems, millimeter wave systems, infrared systems, and satellite broadcast systems); wire based transmission systems (for example, analog and digital cable systems, coaxial connections, fiber optic links, telephone systems, closed circuit systems, Very high speed Digital Subscriber Lines (VDSL), VGD, and any other wired connection); stand-alone systems for providing pre-recorded programs (for example, programs provided on compact discs, digital versatile discs, video tape, PlayStation cartridges, memory sticks, magnetic storage mediums, optical storage mediums, data storage devices, Flash memory, random access memory (RAM), and read only memory (ROM)); and network connections (for example, the Internet, private network, public network, wireless network, wired network, ATM networks wide area network, local area network, and intranet). Such media objects are communicated to the transmitting system by the media object creators 108 over an interface 105 between the media object creators and the input port 103. The interface 105 may be any which facilitates the transfer of media objects to the transmitting system. Similarly, the input port 103 may include any additional processor necessary to format a media object received in a given format into a format compatible with the transmitting system.

Additionally, the transmitting system may transmit the media objects as a live signal or as a pre-recorded signal from a previously recorded medium, and with respect to an Internet connection, the media objects maybe streamed. Similarly, media objects maybe communicated to users using any of the various transmission protocols known in the art including, for example, IEEE 802.11B, RTP, UDP, TCP/IP, Ethernet, and ATM. Further, the media objects may be formatted according to various schemes including, MPEG-1, MPEG-2, MPEG-4, MPEG-7, JPEG, motion JPEG, GIF, QuickTime, ActiveMovie, digital video interactive (DVI), Indeo, and IP wrapped MPEG-4 for streaming. As such, any medium, system, device, or protocol, which facilitates the transfer of media object oriented content to a user may be utilized by the system 100. In short, the transmitting system 102 is content, device, system, medium and protocol independent, provided the selected system supports the transmission and presentation of media objects to users.

The media object creators 108 may also utilize numerous software programs, content creation techniques, and content capturing devices to generate the media objects utilized in the system 100. As stated previously, media objects may include natural, synthetic, and combined natural/synthetic content. The media object creators 108 may utilize any of the various devices and methodologies commonly known to capture or create such content. For example, one creator may utilize microphones to capture audio sounds whereas another creator may utilize a synthesizer to generate the desired audio sounds. The present system 100 is capable of providing targeted advertising and programming to users regardless of the techniques and systems utilized by the media object creators 108. Further, FIG. 1 identifies three types of data commonly utilized in creating media objects, namely: video data 116, audio data 118, and graphic/textual data 120. The system 100, however, is not limited to specific data types and may incorporate any type of data including, but not limited to, audio data, video data, graphic data, textual data, animations, multimedia, slow frame video data, video stills, sequences of individual frames, virtual reality data, live data, pre-recorded data, and computer generated data. Additionally, the media object creators may provide media object based content targeted to a user in any type of program including, for example, a news program, an advertisement, a sports program, an entertainment program, a music video, a game show program, a motion picture program, a video game, a video program, an audio program, an educational program, a live program, a prerecorded program, and in a noncommercial program. Similarly, the media objects may relate to a polling question, provide responses by the user or the media object creator to queries, and may facilitate bidirectional communications (for example, via a chat interface, instant messaging interface, or an electronic mail interface) between and among the media object creator, the transmitting system, the receiving system, and the user. The system 100 suitably includes those software and/or hardware components necessary to provide a chat interface, instant messaging interface and/or an electronic mail interface. Such interfaces are known in the art, and any of such may be suitably incorporated into the system 100 as desired. Additionally, such interfaces may be provided between users, the transmitting system, media object creators, other users, and any other person or entity using a compatible system.

As previously mentioned above, the system 100 also includes a presentation system 112. The presentation system 112 provides at least one output device by which the content of the media objects is presented to a user. Any device capable of presenting media objects to users may be utilized as the presentation system 112. Such devices include, but are not limited to, television receivers, home theater systems, audio systems, computer workstations, laptop computers, personal data assistants, set top boxes, in-home communications systems, wireless communication systems (for example, pagers and wireless telephones), web tablets, virtual reality systems, web phones, printers, heads-up display, gaming consoles, tactile or sensory perceptible signal generators (for example, a vibration or motion), and various other devices or combinations of devices. For example, a presentation system may include a video monitor, an audio sound system, and a motion generator such that a program (for example, one simulating traveling in a car or plane) is simulated using various synchronized media objects. In short, the presentation system 112 is not to be construed as being limited to any specific systems, devices, or components, and may utilize any device capable of presenting media objects to a user.

Similarly, numerous input devices 110 may be utilized by a user to identify themselves, select media objects, select programming signals, and respond to queries. Such input devices include remote control devices, keyboards, scanners (for example, retinal and fingerprint), mouse, trackballs, virtual reality sensors, voice recognition systems, voice verification systems, push buttons, touch screens, joy sticks, brain wave devices, and other such devices.

Additionally, data storage devices 114 are preferably utilized in the system 100 for the temporary or permanent storage of media objects, the content provided in the media objects, transmission signals (for example, in decompressed and/or demultiplexed formats), profile information, operating routines, and any other information utilized by the system 100. The data storage devices 114 may be provided in conjunction with the receiving system 104, may be a stand-alone device co-located with the receiving system 104, may be remotely accessed (for example, via an Internet connection), may be provided in the transmitting system 102, in the user profiling system 106, with the media object creators 108, or at any other location in the system 100. In the preferred embodiment, the data storage devices are provided with the receiving system 104. The data storage devices 114 may also utilize a combination of local and remote storage devices in order to provide the desired features and functions of the system 100. Those skilled in the art appreciate that various data storage devices, algorithms, programs, and systems may be utilized in conjunction with the system 100. Examples of such data storage devices include, but are not limited to, hard drives, floppy discs, CD ROMS, DVDs, tape drives, memory sticks, remote databases, and local databases.

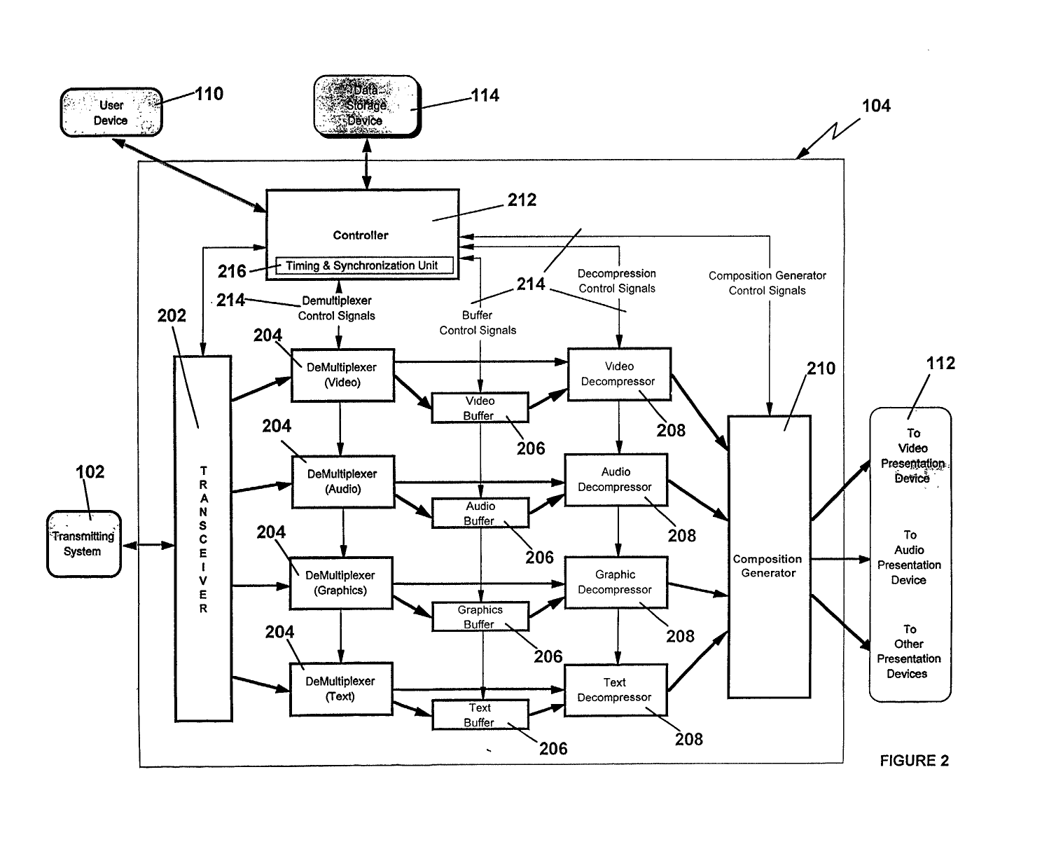

As previously mentioned herein, the system 100 also includes a receiving system 104, which receives the signal provided by the transmitting system 102. As shown in FIG. 2, an illustrative embodiment of a receiving system 104 is provided. It is to be appreciated that such system 104 may be provided in hardware and/or software formats and FIG. 2 is intended to illustrate those functions commonly performed by an MPEG-4 equipped receiving system. The actual layout and configuration of such functional components may vary as desired and commonly appreciated by those skilled in the art. The system 104 is preferably configured to support the reception, selection, and composition of media object based content into audio, video, and audio-video presentations. However, various other forms and methods of presenting content may also be supported by the receiving system 104 including graphical, textual, and virtual reality content. Additionally, for purposes of the present description, the receiving system 104 is described in the context of presenting an audio-video program (with or without graphics or text enhancements such as MPEG stills), but the receiving system 104 is not to be construed as being so limited.

As shown, the receiving system 104 preferably includes a transceiver/interface 202. The transceiver/interface 202 provides the communications connectivity capabilities necessary to receive and transmit communications signals containing media objects or other information between various sources, via various mediums. More specifically, the receiving system 104 is not limited to receiving media objects in communications signals from only specific sources or only via specific mediums and may be configured to support any source and/or medium and provide bidirectional communications, as desired. Those skilled in the art appreciate that the transceiver/interface 202 may utilize various components and systems to receive and process communications signals containing media objects. For example, receiving a communications signal from a CD-ROM player might entail utilizing a serial bus, an RCA-plug, a parallel port, or even a Universal Serial Bus, RGB, firewire (IEEE1494), or any other conventional interface. Whereas, receiving a satellite or radio frequency broadcast may require antennas, low noise amplifiers, low noise block-down converters (LNBs), filters, receivers, and various other components, all of which are known in the art. As such, the receiving system 104 may be configured to receive communications signals containing media objects from any medium and, if desired, from multiple mediums simultaneously. Additionally, the receiving system 104, as desired, may be configured to transmit information to the transmitting system 102 and/or the user profiling system 106.

In addition to establishing the desired communications links with the transmitting system 102, the transceiver/interface 202 also preferably performs standard communications signal processing functions; for example, separating the various communications signals into separate channels and sub-channels, filtering data, restoring lost data, and those various other functions commonly performed by receiving devices. As shown in FIG. 2, the transceiver/interface 202 preferably breaks-out various sub-channels (for example, an audio, video, graphic, and a textual sub-channel) from a selected channel and provides each of the sub-channels to the appropriate demultiplexers 204. For example, a cable signal often contains numerous programming signals (i.e., ABC, CBS, FOX, etc.). Each of these programming signals contains sub-channels (e.g., multiple tracks) in which program elements provide video, audio, and textual information. Those skilled in the art appreciate that such programming signals and sub-channels (e.g., multiple tracks) may be provided in digital or analog signal formats. Additionally, the transceiver/interface 202 separates the incoming cable signal into the various programming signals and, based upon the user's selection, processes the selected programming signal(s) by breaking out the various program elements and sending such elements to the corresponding demultiplexers 204. The separation of transmitted signals into channels and program elements is well known in the art. The receiving system 104 may utilize any methodology and/or components which provide/support the features and functions specified herein and those features and functions commonly performed by receiving systems.

Upon receiving a breakout segment of the program elements from the received transmission signal, the demultiplexers 204 preferably select specific data packets (which are preferably specific media objects) from a plurality of available data packets. Next, the selected data packets are either provided to the corresponding decompressor 208 or sent to a buffer 206 in which the selected data packet is temporarily stored until needed. As is commonly known, communications signals are commonly transmitted after being compressed utilizing a data compression algorithm. The use of data compression and decompression algorithms is well known in the art, and is not discussed in detail herein. Similarly, the use of buffers to store data packets for either real-time streaming or later playback is well known. The system 100 may utilize buffers of various sizes and configurations, as necessary, to support the various data types and data sizes being received by the receiving system 104.

When the time for presenting a specific media object arrives, the data packet containing the media object has preferably been retrieved from the buffer 206, as necessary, and decompressed 208. The decompressed media object is provided to the composition generator 210. The composition generator 210 composes the various data packets into a composite presentation signal. The composite presentation signal may include video elements, audio elements, textual elements, graphical elements, virtual reality elements, and other elements. These elements may then be presented to a user via various devices including, but not limited to, television receivers, home theater systems, audio systems, computer workstations, laptop computers, personal data assistants, set top boxes, in-home communications systems, wireless communication systems (for example, pagers and wireless telephones), web tablets, virtual reality systems, web phones, printers, heads-up display, gaming consoles, tactile or sensory perceptible signal generators (for example, a vibration or motion), and various other devices or combinations of devices. The system 100 supports all levels of interactive multi-media presentation systems and the providing of media objects to users of such systems.

Coordination and control of the various before mentioned functions of the receiving system 104 are provided by the controller 212. The controller 212 provides the various control signals needed to control the numerous components (i.e., the transceiver/interface, demultiplexers, buffers, decompressors, and composition generator) utilized by the receiving system 104 to present media object based content targeted to users. The controller 212 also contains a timing and synchronization unit, which preferably coordinates and synchronizes the spatial and temporal presentation of the various media objects provided in a program. For example, an audio-visual program might contain a synthetic talking head. The timing and synchronization unit coordinates the presentation of the synthetic talking head and the corresponding audio media objects such that the head appears to actually speak the words provided in the audio media objects. Additionally, the controller 212 is preferably in communication with a user device 110. The user device 110 facilitates interaction between the user and the receiving system 104 by receiving selections, requests, queries, and responses by the user to the system 100.

The controller 212 is also, preferably, in communication with a data storage device 114. As mentioned previously, the data storage device 114 may be remote or local to the receiving system 104, as desired. The controller 212 preferably retrieves various configuration and control information from the data storage device 114, as necessary, to receive, process and present the media objects. The data storage device 114 may also be utilized to store user profile information, parental control information, provide additional buffer space for media objects, and perform various other commonly provided data storage functions.

In addition to providing transmission and reception systems for media objects, the present invention provides for the targeting of such media objects to users based upon user profiles and other demographic information. Referring again to FIG. 1 and as mentioned previously, the system 100 includes a user profiling system 106. The user profiling system 106 utilizes demographic and/or user specific information to determine which of the various media objects are available, at any time, to present and target to a user at a particular instance during a program. The user profiling system 106 uses information collected via a variety of sources and/or methodologies to develop a user profile and determine which media objects to present to a user during a program. In a most basic embodiment, the user profile information is based upon demographic or regional information collected/generated by the transmitting system 102 or by the media object creators 108. The user profiling system 106 may also be provided by an online service provider who generates user profiles based upon user responses to surveys, web page hits, demographic information, user viewing habits (for example, compilations thereof provided by a cable operator or via a TiVO® unit), purchasing behavior (both on-line and non-on-line purchases), regional information, and/or statistical information.

For example, automobile companies realize that residents of San Diego generally purchase more convertibles than residents of Seattle. As such, a national television advertisement for a Ford Mustang® might include a media object directing a San Diego network affiliate's transmitting system 102 to select from a national data feed media objects (i.e., a data packet) depicting a convertible in San Diego. Meanwhile, during the broadcast of the same commercial, the network broadcaster may direct the Seattle affiliate to select media objects depicting a hard top Mustang in Seattle. The various other elements of the commercial (i.e., the actors, voice, and music) might be the same nation-wide with only the media objects for the car's roof and the baseline scenery being interchangeable.

Similarly, the selection of the media object (i.e., the convertible or the hard top roof) might also be accomplished by the receiving system 104, with or without user input. In this embodiment, both media objects (the convertible roof and the hard top roof) are transmitted as multiplexed data packets in the same programming signal to the receiving system 104. The receiving system 104 accesses a geographic region indicator which is preferably stored in the data storage device 114 to determine which of the received data packets the demultiplexer 204 is to select and provide to the other devices within the system 104 for further processing. As may be appreciated, the data storage device 114 may be automatically or manually set with a region indicator via commonly known processes such as using a telephone area code to designate a geographic area. Those skilled in the art appreciate the various methods by which a receiving system 104 may be configured to respond to a regional, demographic, or other generic (non-user specific) indicator.

In another embodiment, the system 100 is configured to provide even more specific media object based targeted content. In this embodiment, the system 100 is configured to utilize specific information provided by the user, for example, answers to a survey or questionnaire. Based upon the user provided information, the user profiling system 106, which is preferably co-located with the transmitting system 102 and/or the media object creators 108, collects the data, filters the data, sorts the data, and manipulates the data to generate a user profile. Statistical sampling and other data manipulation techniques may also be utilized to characterize and establish user profiles for specific users or other groupings of users (for example, a grouping based upon geographic location). Additionally, V-chip data (i.e., a chip utilized to set parental controls on a multimedia device such as a television) may be utilized to generate a user profile. For example, information provided by a parent with four children aged 6 months to 10 years old may be used to generate a profile of an individual who might be interested in purchasing a minivan. In contrast, a single professional with no children would probably generate a profile of a user interested in a sports car. Thus, the system 100 uses the provided information and/or other information and statistics to generate a user profile. The user profile information, in turn, is utilized by media object creators 108, broadcasters, local affiliates, and others on the transmitting side of the system to provide targeted advertising and programming to users by originating and transmitting media objects targeted to specific users and/or classifications of users.

Throughout this description reference has been made to using media objects to provide targeted advertising and programming based upon user profiles. While the traditional methods of advertising goods and services (for example, commercial advertisements during interruptions in a program) may be utilized by the system 100, the system also supports non-interrupting advertising and programming by providing program content (as compared with the content of an advertisement) in which media objects in the program itself are selected and presented to the user based upon a user profile. These media objects may then be selected, deleted and saved by the user while being presented with the underlying program. Such actions by the user, for example, deleting a first media object while selecting a second media object, may be suitably utilized by the system to determine a user profile. For example, a user who selects a sports car might result in a profile of a person who is more concerned about driving excitement than the person who selects an economy car. Such profile information is suitably stored by the receiving system 104 and/or the transmitting side (i.e., the transmitting system and/or the media object creators) such that subsequent media objects may then be inserted by the program creators and/or the transmitting system into the programming signal sent to the profiled user. In this manner, the program content presented to a user may be uniquely tailored to a user such that targeted content is provided without any user actions required and without any interruptions of the advertising and/or programming.

The system 100 may also be configured to operate at a highly interactive level of user profiling. In this embodiment, the user profiling system 106 is preferably in communication with both the transmitting system and/or the media object creators 108, and the receiving system 104. As the user selects programs and content to receive, the receiving system 104 relays such information to the user profiling system 106 via a communications link. The user profiling system 106 may be a stand-alone system, an Internet based system, or any other system capable of generating user profiles based upon user viewing habits (or listening habits—in the case of an audio program) and/or purchasing behavior. Similarly, the communications link between the receiving system 104 and the user profiling system 106 may be any link including, but not limited to, an Internet link, a telephone link, a digital subscriber link, a wireless link, and a cable link. Additionally, communications links between the user profiling system 106, the transmitting system 102, the media object creators 108, and the data storage device 114 are also preferably provided, thereby allowing the media object creators and transmitters (as desired) to program media object selection guidelines into the receiving system 104, at any time, based upon the user profile.

While the user profiling system 106 is preferably configured to interface with both the transmitting system 102 and the receiving system 104, the system 100 may also be configured such that user profiling information and features are utilized only by the receiving system 104. In such an embodiment, the media object creators 108 and transmitting system 102 suitably create media objects for predetermined profiles and transmit such media objects to the receiving system 104. The receiving system 104 then determines which of the various media objects to use based upon the user profile provided by the receiving system 104 and/or the data storage device 114. As such, this embodiment does not require bidirectional communication links between the receiving system 104 and the transmitting system 102.

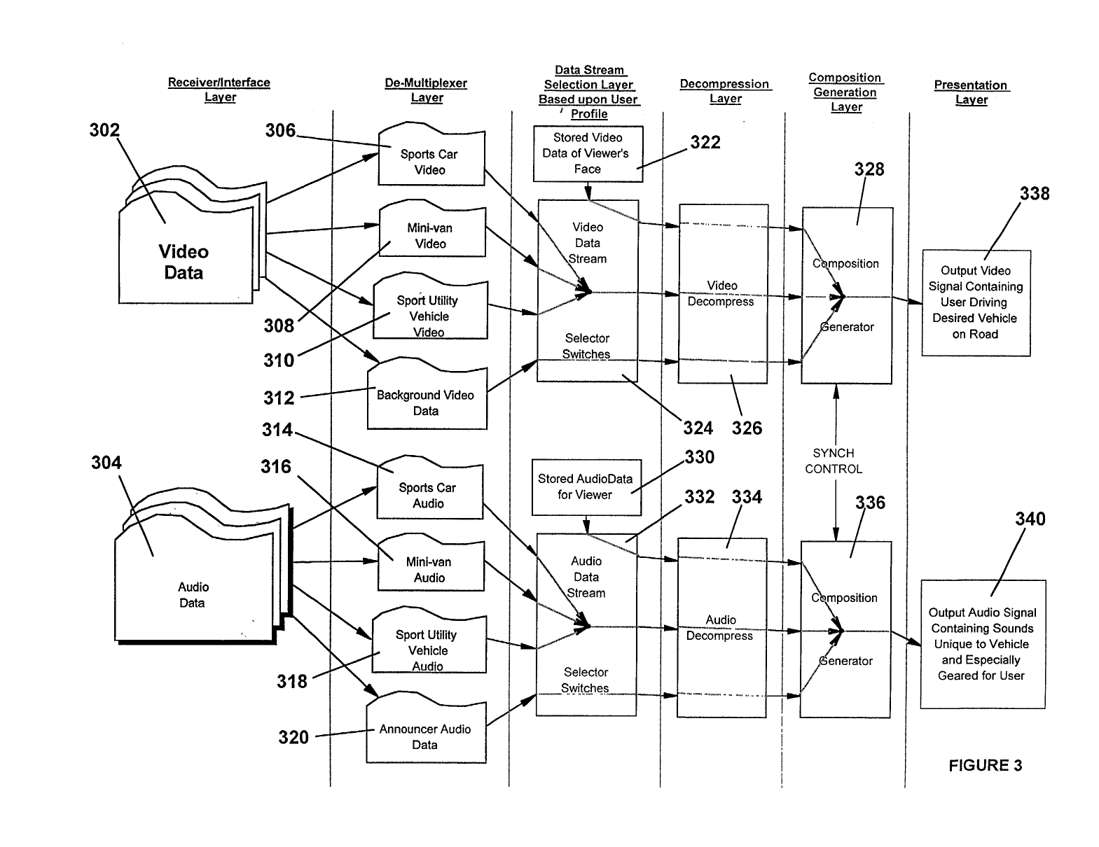

One example of such an embodiment in use is illustrated in FIG. 3. As shown, the receiving system 104 receives a program containing multiple video and audio objects of which at least one of each is selected for presentation to the user based upon a locally stored user profile. For example, an automobile manufacturer desires to market their vehicles during the Super Bowl. Instead of presenting a separate commercial for each of its potential markets (for example, the sports car, mini-van, and sport utility markets), the manufacturer merely provides a single commercial with multiple media objects (for example, video media objects and associated audio media objects for each type of vehicle) while also providing a baseline promotional media object 320 (for example, a promotional special such as 2.9% financing or $1000 back) overlaid on a given background media object 312. Further, real time marketing conditions can dictate the selection and presentation of an object. For example, local sales taxes may be included in the sales price in one town (or geographical area) versus another town, thus leading to different promotional objects.

Each of these media objects are received by the receiving system 104 and preferably broken out into video data 302 and audio data 304 streams, each of which contains numerous data packets representing individual media objects. For example, video media objects for a sports car 306, a minivan 308, and a sport utility vehicle 310 are provided as well as the corresponding audio media objects 314, 316, and 318. The controller 212 suitably determines, based on the user profile and/or other variables (for example, a demographic area), which of the media objects to select 324 and 332.

Additionally, in certain embodiments wherein the advertiser desires a digital version of a user to appear in the commercial 322, such a media object may also be generated and selected. For example, the commercial might superimpose a media object of the user as the driver of the vehicle. Similarly, audio data on the user 330 (for example, a specific language or dialect) might also be selected by the controller.

Upon selecting a video media object and an audio media object, such objects are then commonly decompressed 326 and 334, respectively, and provided to the composition generators 328 and 336. The composition generator then generates output signals for presentation on the corresponding video and audio presentation devices 338 and 340. In short, the present invention enables content providers to target their advertising and programming to users by providing media objects which are selected either by the transmission side and/or the receiving side based upon a user's profile.

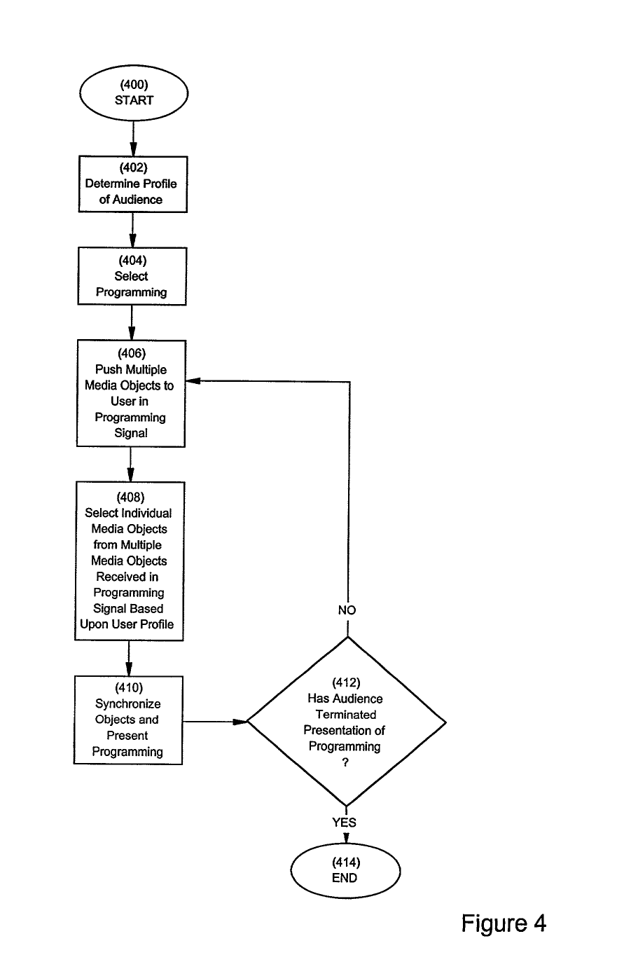

One process preferably utilized by the aforementioned system to provide media object based targeted advertising and programming is illustrated in FIG. 4. As shown, the process provides for the pushing of a media object based advertisement, which is targeted to specific users and does not rely upon the user selecting or specifying media objects. The process begins with determining profiles for the user audience (Block 402). It is to be appreciated that various methods may be used to determine a make-up of a given user audience, including, for example, using a sign-on and password to a system transmitting the program content. Any system or process for determining a user audience (including statistical processes) may be utilized. Preferably, the user profiles are determined at the transmitting system or by the media object creators such that media objects are pushed to users without requiring any user input or interaction. However, the user profiles, as discussed previously, may be determined at the receiving system or in combination with the receiving system. When the receiving system determines which media objects are to be presented to the user, multiple media objects are preferably pushed to the user and the receiving system merely selects one of the pushed media objects, based upon the user profile, and does not request media objects from the transmitting side.

After the user profiles are determined, the process continues with the user selecting the desired programming (Block 404) to be received and presented. Preferably the user's choice of programming is communicated to the transmitting side (i.e., to the media object creators 108 and the transmitting system 102) by the receiving system 104. As is commonly known, many transmitting systems (especially cable systems and satellite systems) enable a user to select from numerous programming options at any instant. The present process preferably provides for the real-time communication of user programming choices back to the transmitting side such that targeted media objects may be pushed to the user for presentation during the selected programming signal. However, it is to be appreciated that the process of FIG. 4 may also be accomplished in systems, which do not provide feedback of user programming choices to the transmitting side. In such systems, the receiving system 104 utilizes various stored profiling rules and protocols (which, for example, may be periodically downloaded and updated in the system or permanently built-in), which correspond to profiles pre-established at the transmitting side, to determine which media objects in a selected program to present to a user, based upon the user's profile.

Additionally, it is to be appreciated, that the media objects selected for transmission to a user may be in conformance with a user profile, or may be items which attempt to steer a user towards a second profile. For example, a user profile indicating that a user prefers Coca-Cola® might result in media objects associated with Pepsi® products being presented during the program, perhaps as an attempt to lure the user into trying Pepsi products. Further, as discussed above, such media objects may be provided as separate advertisements or in the program itself. For example, a program may contain a scene in which the actor drinks from a soft drink can. The present invention enables content creators to specify from which soft drink can the actor drinks by using media objects which are selected by the transmitting system or the receiving system based upon a user profile. For example, the actor may drink from a Pepsi can instead of a Coca-Cola can. Those skilled in the art appreciate that MPEG-4 and other object based formats enable the content creators, the transmitting system, and/or the receiving system to effortlessly and seamlessly replace a first media object of a Pepsi can with a second media object of a Coke can, such that the actor appears to drink from the desired product.

After the programming choice has been made by the user, the process preferably continues with pushing multi-object programming data to the user (Block 406). Preferably, as mentioned previously, the pushed objects are based upon profiles established on the transmitting side based upon the user viewing habits and programming choices. Additionally, for any given program, media object creators generally desire to create media objects for a given number of profiles (for example, Coca-Cola drinkers might be a first profile, while Pepsi drinkers are a second profile). Instead of creating a unique media object for each user's profile, the process preferably pushes media objects to specific users based upon user identifiers. Such identifiers are periodically loaded into the receiving system 104 and/or data storage device 114 such that when the receiving system 104 receives the multi-object programming data, the receiving system 104 is programmed to select a specific media object based upon the user identifier. It is to be appreciated, however, that the identification of users who are to receive specific media objects may also be determined and accomplished by various other commonly known data routing and distribution techniques, for example assigning unique nodes on a network to each user. The present invention is not limited to any specific embodiment, and as bi-directional data link throughput capacity increases, various other routing techniques may be utilized to push media object based targeted advertising and programming to users.

Upon receiving the multi-object programming signal, the receiving system 104 then selects specific media objects for decompression, composition and presentation based upon the user's profile (Block 408). The selection of the media objects may be accomplished independently by the receiving system, in conjunction with the user profiling system, and/or in conjunction with the transmitting side. Additionally, the receiving system 104 maybe configured such that the media objects and/or profiles available are selected by the user via the user input device 110. Such user control features might prove popular, for example, when a user is watching a program, which for an adult profile contains adult content, but for an adolescent profile does not contain the adult content. By merely selecting the appropriate profile (with passwords, voice recognition, or other features preventing unauthorized access to the adult content), the system 100 may be configured, for example, to allow parents to control the content of programs, and prevent adolescents from watching adult oriented content.

At this point of the process, the media objects to be presented to the user have been selected. The process then continues with synchronizing the various objects and presenting the programming (Block 410). Since each program may contain hundreds of media objects, the process determines whether the selected program has been terminated (for example, by switching to another channel) (Block 412). If the programming has not been switched, the process ends and restarts with the selection of the new programming signal since a user's profile may vary depending upon the chosen programming. For example, a Kansas State fan watching a national championship football game between Kansas State University and Virginia Tech would probably be interested in receiving an audio broadcast (e.g., player, coach, in-stadium announcer, or radio broadcast), highlights, and other information which is oriented towards Kansas State, whereas the Virginia Tech fan would prefer to hear the audio broadcast, etc., which is oriented towards their team. By using user profiles and media object based content, each fan can receive the programming they desire. However, when watching the PGA championships, both users may have the same profile and thus do not need separate audio programming, etc. Thus, the system 100 may also be configured to accommodate multiple profiles for each user, wherein the profiles are dependent upon the programming selected or other variables.

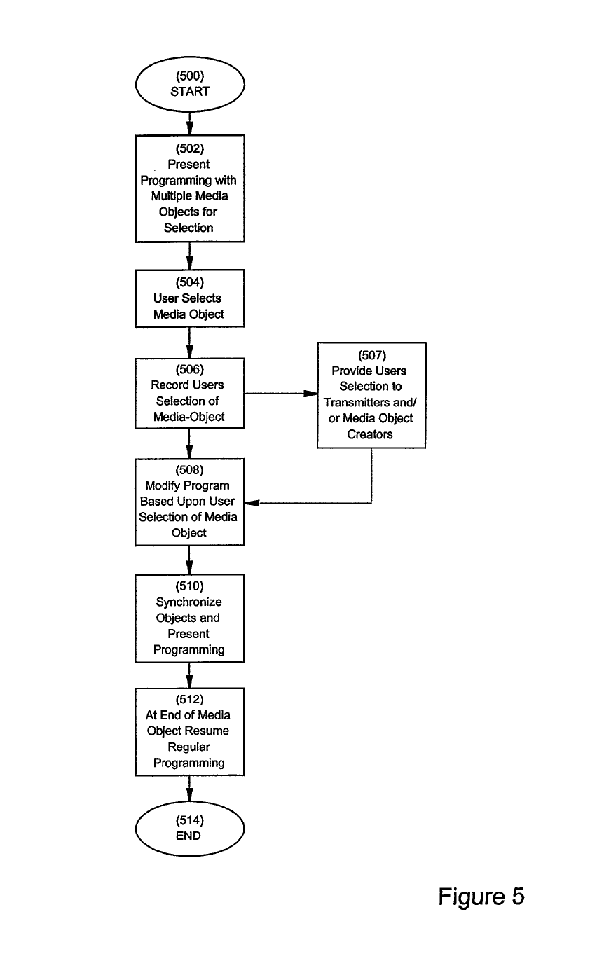

FIG. 5 illustrates a process flow utilized to pull media objects by a user. The pulling of content occurs when a user actively requests information from a provider. Commonly, such pulls occur, for example, by a user selecting a particular Web page on the Internet, selecting a particular data feed, etc. In addition to pulling specific programming, Web pages and other content, the present invention enables a user to pull specific media objects within a program. For example, a broadcast of a football game may provide users with the option of selecting a desired camera angle for a play (for example, the blimp view, the sideline view, the quarterback view, etc.) by providing multiple media objects within the programming signal. The present invention allows a user to select a media object(s) presenting the desired view and the corresponding audio (for example, the quarterbacks's verbal commands). Alternatively, the user could pull up video stills or graphics/text enhancements for detailed statistics. Advertising can be included in such media objects (for example, the quarterback helmet cam might include advertising by Riddell®, the helmet manufacturer).

As shown in FIG. 5, the pull process begins with the transmitting side presenting programming which contains multiple media objects, which the user may select (Block 502). The receiving system 104 receives the programming signal and provides the user (when the user select option is enabled) with a menu of choices of media objects, view angles, etc. which can be selected via the user input device 110. However, the present invention is not limited to requiring a user to select a media object via menus and other traditional methods. Since each element of the programming signal is a distinct media object (for example, as provided in programming utilizing the MPEG-4 format), the user may simply select or designate the object and obtain the desired view or information. For example, during a broadcast of the Indy 500, a user could select a car on the screen and then receive the programming from the driver's viewpoint. Thus, the process of FIG. 5 allows the user to determine which content (media objects) they desire to receive (Block 504).

Upon the user's selection of a media object, the process continues with recording the user selection in the user profiling system (Block 506). The user's selections are utilized by the user profiling system to create a more complete profile of the user. For example, a user selecting a media object relating to hiking boots, is most likely interested in additional outdoor gear. Such information may be utilized to tailor advertising to such gear during breaks, for example, in football games. The process also provides information about the user's selections to the transmitting side (Block 507). The information provided may range from the highly specific to the non-specific and anonymous habits of a geographic region, as required by privacy constraints, data processing capabilities, and other factors.

Upon receiving the user's selection of a media object, the process modifies the programming (Block 508). At this point the receiving system selects and displays the image from the quarterback cam or the particular racecar. Additionally, when a bi-directional communications link is provided between the transmitting side and the receiving system, media objects might actually be modified by the transmitting side prior to transmission. For example, the next commercial advertisement or programming segment may include images from the earlier selected view.

Next, the process continues with the receiving system receiving the media objects, selecting the correct object, synchronizing the various objects and presenting the programming to the user (Block 510). Preferably, the selection of media objects by the user and the presentation of such objects occurs instantaneously from the user's perspective. Those skilled in the art appreciate the data processing speeds, buffers, transmission capabilities and other system capabilities that may be necessary to provide the before mentioned pull of media objects. The present invention may utilize any systems and processes, which provide such capabilities.

When the media object being presented ends, the process continues with the regular programming being presented (Block 512). For example, after a play is viewed through the quarterback cam, the presentation returns to the sideline view or regular programming view and then, for example, allows the user to select another view or continue with the current view. The present invention may also be configured to continuously process a stream of media objects until a command is received from the user. During such a presentation, the system 100 continues to provide targeted advertising in the form of media objects, record user responses thereto, and create/modify user profiles. In short, the process of FIG. 5 enables a user to select and pull content, based upon their individual preferences, via the use of media objects. Such pulls may then be utilized to generate user profiles and target advertising to users based upon such profiles.

While the present invention has been described in relation to a preferred system embodiment and various process flows, it will be appreciated by those skilled in the art that changes in the above descriptions or illustrations may be made with respect to form or detail without departing from the spirit and scope of the present invention.

We claim:

1. A system for transmitting a media object containing content targeted to a user based upon a user profile comprising:
an input port for receiving a media object containing content targeted to a user profile; and
a transmitting system, connected to the input port, which transmits the media object in a programming signal to a user associated with the user profile;
whereupon receiving the media object from the input port, the transmitting system determines the user profile targeted by the media object, identifies a user associated with the user profile, and transmits the media object to the identified user.

2. The system of claim 1, wherein the user profile is based upon information selected from the group consisting of: response by a user to a survey, demographic information, user viewing habits, selection of a media object by a user during a programming signal, purchase behavior, a compilation of viewing habits from at least two users, statistical information, and regional information.

3. The system of claim 2, wherein the user profile is generated by a user profiling system co-located with the transmitting system.

4. The system of claim 1, wherein the programming signal further comprises a signal in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

5. The system of claim 1, wherein the programming signal is transmitted by the transmitting system to a receiving system via a transmission medium selected from the group consisting of: broadcast, microwave, millimeter wave, wireless, wireline, satellite, cable, and fiber optics.

6. The system of claim 1, wherein the media object is received by the input port over a transmission medium selected from the group consisting of: broadcast, wireless, wireline, microwave, millimeter wave, satellite, cable, and fiber optics.

7. The system of claim 1, wherein the transmitting system further comprises a wireless system selected from the group consisting of: television broadcasting system, radio broadcasting system, microwave systems, millimeter wave systems, infrared systems, wireless telecommunications system, and a satellite broadcasting system.

8. The system of claim 1, wherein the transmitting system further comprises a wired system utilizing a communications medium selected from the group consisting of: cable, coaxial cable, twisted pair cable, fiber-optic cable, telephone cable, and closed circuit cable.

9. The system of claim 1, wherein the input port receives the media object via a stand-alone system from a data storage medium selected from the group consisting of: compact disc, digital versatile disc, video tape, gaming cartridge, memory stick, magnetic storage medium, optical storage medium, Flash memory, random access memory, and read only memory.

10. The system of claim 1, wherein the transmitting system transmits the programming signal to the user via at least one network selected from the group consisting of: the Internet, intranet, private network, wired network, ATM network, wireless network, wide area network, local area network, and a public network.

11. The system of claim 10, wherein the programming signal is streamed to the user over the network.

12. The system of claim 1, wherein the media object is transmitted in a format selected from the group consisting of: MPEG-1, MPEG-2, MPEG-4, MPEG-7, JPEG, motion JPEG, GIFs, QuickTime, ActiveMovie, DVI, and Indeo.

13. The system of claim 1, wherein the transmitting system utilizes a transmission protocol selected from the group consisting of: RTP, UDP, TCP/IP, and ATM to transmit the programming signal.

14. The system of claim 1, wherein the programming signal includes at least one media object containing content related to at least one program type selected from the group consisting of: news program, sports program, virtual reality program, entertainment program, music video, game show program, motion picture program, video program, live program, audio program, polling question, educational program, non-commercial program, and a pre-recorded program.

15. The system of claim 1, wherein the programming signal includes at least one media object containing advertising related content.

16. The system of claim 1, wherein the transmitting system receives a first media object and second media object from the input port, combines the first media object and the second media object into a composite programming signal and transmits the composite programming signal, whereupon receiving the composite programming signal a receiving system selects one of the first media object and the second media object based upon the user profile.

17. A system for generating a media object containing content targeted to a user profile, wherein the media object is included in a programming signal transmitted by a transmitting system to a user associated with the user profile, comprising:
a media object creator which generates a media object containing content targeted to a user profile; and
an interface, which facilitates the transfer of the media object to a transmitting system, which transmits the media object in a programming signal to a user associated with the user profile;
wherein the media object creator generates a media object, identifies a user profile as a target for the media object, and outputs the media object; whereupon receiving the media object, a transmitting system determines the user profile targeted by the media object and transmits the media object to a user associated with the targeted user profile.

18. The system of claim 17, wherein the user profile is based upon information selected from the group consisting of: response by a user to a survey, demographic information, user viewing habits, selection of a media object by a user during a programming signal, purchase behavior, a compilation of viewing habits from at least two users, statistical information, and regional information.

19. The system of claim 18, wherein the user profile is generated by a user profiling system co-located with the media object creator.

20. The system of claim 17, wherein the media object further comprises a signal in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

21. The system of claim 17, wherein the interface further comprises a transmission medium selected from the group consisting of: broadcast, microwave, millimeter wave, wireless, wireline, satellite, cable, and fiber optics.

22. The system of claim 17, wherein the media object creator generates a media object for storage on a data storage medium selected from the group consisting of: compact disc, digital versatile disc, video tape, gaming cartridge, memory stick, Flash memory, magnetic storage medium, optical storage medium, random access memory, and read only memory.

23. The system of claim 17, wherein the media object is transferred to the transmitting system in a format selected from the group consisting of: MPEG-1, MPEG-2, MPEG-4, MPEG-7, JPEG, GIFs, QuickTime, ActiveMovie, DVI, and Indeo.

24. The system of claim 17, wherein the media object includes content related to at least one program type selected from the group consisting of: news program, sports program, virtual reality program, entertainment program, music video, game show program, motion picture program, video program, live program, educational program, audio program, polling question, non-commercial program, and a pre-recorded program.

25. The system of claim 17, wherein the media object includes advertising related content.

26. A system for transmitting at least two media objects, each media object containing content targeted to at least one user profile, wherein a system receiving the at least two media objects selects a media object for presentation to a user based upon an association of the user with one of the user profiles, comprising:
an input port for receiving at least two media objects for incorporation within a programming signal, wherein each media object contains content targeted to a unique user profile; and
a transmitting system, connected to the input port, which transmits a programming signal containing each media object received at the input port;
whereupon receipt of the programming signal by a receiving system, the receiving system identifies the user profile to which each media object received in the programming signal is targeted, determines a user profile associated with a user, selects a media object containing content targeted to the user profile associated with the user, and outputs the selected media object to a presentation system for presentation to the user.

27. The system of claim 26, wherein a first media object contains content targeted to a first user profile, and a second media object contains content targeted to a second user profile.

28. The system of claim 26, wherein a first media object and a second media object both contain content targeted to a first user profile.

29. The system of claim 26, wherein the user profile is based upon information selected from the group consisting of: response by a user to a survey, demographic information, user viewing habits, purchase behavior, statistical information, selection of a media object by a user during a programming signal, and regional information.

30. The system of claim 26, wherein the programming signal further comprises a signal in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

31. The system of claim 26, wherein the programming signal is transmitted by the transmitting system to the receiving system via a transmission medium selected from the group consisting of: broadcast, wireless, wireline, microwave, millimeter wave, satellite, cable, and fiber optics.

32. The system of claim 26, wherein the input port receives at least one of the media objects via a stand-alone system from a data storage medium selected from the group consisting of: compact disc, digital versatile disc, video tape, gaming cartridge, memory stick, magnetic storage medium, optical storage medium, Flash memory, random access memory, and read only memory.

33. The system of claim 26, wherein at least one of the media objects contain content related to at least one program type selected from the group consisting of: news program, sports program, virtual reality program, entertainment program, music video, game show program, motion picture program, educational program, video program, live program, audio program, polling question, non-commercial program, and a pre-recorded program.

34. The system of claim 26, wherein at least one of the media objects contain advertising related content.

35. A system for transmitting a media object containing content targeted to a user profile comprising:
a means for obtaining a media object containing content targeted to a user profile;
a means for identifying a user associated with the targeted user profile; and
a means for transmitting the media object in a programming signal to the user; wherein the means for transmitting determines the user profile targeted by the media object, identifies at least one user associated with the user profile, and transmits the media object to the user.

36. The system of claim 35, wherein the programming signal comprises a signal in a form selected from the group consisting of: video signal, audio signal, combined audio and video signal, animation, text, graphics, multimedia, slow frame video, video stills, sequence of individual frames, virtual reality data, live data, pre-recorded data, natural data, synthetic data, combined natural and synthetic data, and computer generated data.

37. The system of claim 35, wherein the media object based content is obtained via a transmission medium selected from the group consisting of: broadcast, wireless, microwave, millimeter wave, satellite, cable, and fiber optics.

38. The system of claim 35, wherein the media object includes at least one media object in a format selected from the group consisting of: MPEG-1, MPEG-2, MPEG-4, MPEG-7, JPEG, GIFs, QuickTime, ActiveMovie, DVI, and Indeo.

39. The system of claim 35, wherein the means for transmitting utilizes a transmission protocol selected from the group consisting of: RTP, UDP, TCP/IP, and ATM.

40. The system of claim 35, wherein the means for transmitting streams the programming signal to the user.

41. The system of claim 36, wherein the programming signal includes at least one media object providing content related to at least one program type selected from the group consisting of: news program, sports program, entertainment program, music video, game show program, motion picture program, video program, live program, audio program, noncommercial program, polling question, and a pre-recorded program.

42. The system of claim 35, wherein the programming signal includes at least one media object providing advertising related content.

43. The system of claim 35, wherein the user profile is based upon information selected from the group consisting of: responses to a survey, demographic information, purchase behavior, regional information, viewing habits, and selections of media objects during a programming signal.

44. The system of claim 35, wherein the system further comprises a means for storing data prior to transmission of the media object in the programming signal.

45. The system of claim 44, wherein the means for storing data further comprises at least one storage medium selected from the group consisting of: compact disc, digital versatile disc, game cartridge, memory stick, magnetic storage medium, optical storage medium, random access memory, read only memory, Flash memory, hard disc drive, and floppy disc.

46. The system of claim 35, wherein the means for identifying a user associated with the targeted user profile further comprises a web site accessible by at least one network selected from the group consisting of: the Internet, intranet, private network, ATM network, wired network, wireless network, wide area network, local area network, and a public network.

47. A system for generating media object based content targeted to a user profile wherein the media object based content is included in a programming signal transmitted by a transmitting system to a user associated with the user profile, comprising:
a means for creating a media object, wherein the media object contains content targeted to a user profile; and
a means for providing the media object to a transmitting system, wherein the transmitting system transmits the media object in a programming signal to a user associated with the user profile;
wherein the means for creating a media object identifies a user profile as a target for the content contained in the media object and outputs the media object to the transmitting system, whereupon receiving the media object the transmitting system determines the user profile targeted by the means for creating and transmits the media object to a user associated with the determined user profile.

48. The system of claim 47, wherein the means for creating a media object further comprises a television producer, a radio program producer, an Internet content creator, a motion picture producer, a sports program producer, a game show producer, a virtual reality program producer, a music video producer, an advertisement producer, a live event producer, a prerecorded event producer, and a pollster.

49. The system of claim 47, wherein the user profile is based upon information selected from the group consisting of: response by a user to a survey, demographic information, user viewing habits, selection of a media object by a user during a programming signal, a compilation of user viewing habits from at least two users, user purchase behavior, statistical information, and regional information.

50. The system of claim 47, wherein the media object further comprises a signal in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

51. The system of claim 47, wherein the media object is created using a format selected from the group consisting of: MPEG-1, MPEG-2, MPEG-4, MPEG-7, JPEG, motion JPEG, GIFs, QuickTime, ActiveMovie, DVI, and Indeo.

52. A method for transmitting a media object containing content targeted to a user profile comprising:
obtaining a media object containing content targeted to a user profile;
identifying the user profile targeted by the media object;
identifying at least one user associated with the user profile; and
transmitting the media object in a programming signal to the at least one user associated with the user profile;
whereupon receipt of the programming signal, the media object is presented to the user associated with the user profile.

53. The method of claim 52, wherein the media object further comprises content in a form selected from the group consisting of: a video signal, an audio signal, a combined audio and video signal, animation, text, graphics, multimedia, slow frame video, video stills, sequence of individual frames, virtual reality data, live data, pre-recorded data, natural data, synthetic data, combined natural and synthetic data, and computer generated data.

54. The method of claim 52, wherein the media object obtained is in a format selected from the group consisting of: MPEG-1, MPEG-2, MPEG-4, MPEG-7, JPEG, motion JPEG, GIFs, QuickTime, ActiveMovie, DVI, and Indeo.

55. The method of claim 52, wherein the media object is transmitted to the user in a programming signal transmitted via a transmission medium selected from the group consisting of: the broadcast, a wireless, satellite, cable, and fiber optics.

56. The method of claim 52, wherein the media object contains content which relates to at least one program type selected from the group consisting of: news program, sports program, entertainment program, music video, game show program, motion picture program, video program, live program, audio program, non-commercial program, a polling question, and a pre-recorded program.

57. The method of claim 52, wherein the media object contains advertising related content.

58. The method of claim 52, wherein the method further comprises:
establishing a chat interface between a user and a system transmitting the media object, wherein the chat interface utilizes at least one media object to facilitate communications.

59. The method of claim 52, wherein the method further comprises:
establishing an electronic mail interface between a user and at a system transmitting the media object, wherein the electronic mail interface utilizes at least one media object to facilitate communications.

60. The method of claim 52, wherein the method further comprises establishing an instant messaging interface with a user receiving a media object.

61. The method of claim 52, wherein the step of identifying a user profile targeted by the media object further comprises:
obtaining user information; and
compiling the user information into the user profile.

62. The method of claim 61, wherein the user information is obtained from at least one source selected from the group consisting of: responses to a survey, demographic information, regional information, user viewing habits, user purchase behavior, statistical information, and user selections of media objects during a programming signal.

63. The method of claim 52, wherein the step of identifying at least one user associated with the user profile is accomplished by a receiving system.

64. The method of claim 52, wherein the method further comprises storing the media object in a data storage device and retrieving the media object from the data storage device at a designated time for transmitting the media object in the programming signal to the user.

65. The method of claim 52, wherein the data storage device is at least one selected from the group consisting of: compact disc, digital versatile disc, video tape, gaming cartridge, memory stick, magnetic storage medium, optical storage medium, random access memory, Flash memory, and read only memory.

66. A method for generating a media object containing content targeted to a user profile, wherein the media object is included in a programming signal transmitted by a transmitting system to a user associated with the user profile, comprising:
generating a media object containing content targeted to a user profile; and
outputting the media object to a transmitting system, wherein the transmitting system transmits the media object in a programming signal to a user associated with the user profile;
wherein the transmitting system identifies the user profile targeted by the media object, identifies at least one user associated with the user profile, and transmits the media object in a programming signal to the user.

67. The method of claim 66, wherein the user profile is based upon information selected from the group consisting of: response by a user to a survey, demographic information, user viewing habits, selection of a media object by a user during a programming signal, user purchase behavior, statistical information, a compilation of viewing habits of at least two users, and regional information.

68. The method of claim 66, wherein the method further comprises the step of obtaining the user profile from a user profiling system provided by an online service provider accessible via a network selected from the group consisting of: the Internet, intranet, private network, wired network, ATM network, wireless network, wide area network, local area network, and a public network.

69. The method of claim 66, wherein the method further comprises obtaining the user profile from a user profiling system in communication with a system selected from the group consisting of: the transmitting system, and a system for receiving the programming signal transmitted by the transmitting system.

70. The method of claim 67, wherein the media object further comprises a signal in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

71. The method of claim 67, wherein the method, prior to transmitting the media object, further comprises storing the media object on a data storage medium selected from the group consisting of: compact disc, digital versatile disc, video tape, gaming cartridge, memory stick, magnetic storage medium, optical storage medium, random access memory, Flash memory, and read only memory.

72. The method of claim 67, wherein the method further comprises:
generating a first media object associated with a first user profile and a second media object associated with a second user profile; and
outputting at least one of the first media object and the second media object to the transmitting system based upon an identification of the user;
wherein both the first media object and the second media object are outputted when a system generating the media objects receives no identification of the user, and the first media object is outputted when the user is identified as associated with a first user profile, and the second media object is outputted when the user is identified as associated with the second user profile.

73. A computer readable medium containing instructions for transmitting a media object containing content targeted to a user profile, by:
receiving media object containing content targeted to a user profile from a media object creator;
identifying at least one user profile for receiving the media object; and
transmitting the media object in a programming signal to a user associated with the user profile.

74. The computer readable medium as described in claim 73, wherein the media object is transmitted in a format selected from the group consisting of: MPEG-1, MPEG-2, MPEG-4, MPEG-7, JPEG, motion JPEG, GIFs, QuickTime, ActiveMovie, DVI, and Indeo.

75. The computer readable medium as described in claim 73, wherein the programming signal is transmitted utilizing a system selected from the group consisting of: a wireless transmission system, a wire based transmission system, a stand-alone system, and a network system.

76. The computer readable medium as described in claim 73, wherein the media object relates to at least one program type selected from the group consisting of: news program, sports program, entertainment program, music video, game show program, motion picture program, video program, live program, audio program, non-commercial program, educational program, a polling question, and a pre-recorded program.

77. The computer readable medium as described in claim 73, wherein the media object relates to an advertisement.

78. The computer readable medium as described in claim 73, wherein the instructions further provide for receiving and transmitting a first media object and a second media object, wherein each media object is associated with a user profile, by:
receiving a first media object associated with a first user profile and a second media object associated with a second user profile; and
transmitting the first and second media objects in the programming signal; wherein a receiving system selects one of the first and the second media objects for presentation to a user based upon an association of the user with one of the first user and the second user profile.

79. A system for presenting media object containing content targeted to a user profile comprising:
a receiving system which receives a programming signal containing at least one media object containing content targeted to a user profile, extracts the media object from the programming signal, and outputs the media object; and
a presentation system, in communication with the receiving system, which receives the media object from the receiving system and presents the media object to a user associated with the user profile;
whereupon presentation of the media object to the user, the user is presented with content targeted to the user based upon the user profile.

80. The system of claim 79, wherein the presentation system utilizes at least one device selected from the group consisting of: television, home entertainment system, computer workstation, personal data assistant, virtual reality system, video presentation system, audio presentation system, sound reproduction system, telephonic system, gaming console, cable box, and set top box.

81. The system of claim 79, wherein the media object includes content in a form selected from the group consisting of: video signal, audio signal, combined audio and video signal, animation, text, graphics, multimedia, slow frame video, video stills, sequences of individual frames, virtual reality, live, pre-recorded, natural, synthetic, combined natural and synthetic, and computer generated signals.

82. The system of claim 79, wherein the programming signal is received via a transmission medium selected from the group consisting of: broadcast, wireless, wireline, microwave, millimeter wave, satellite, cable, and fiber optics.

83. The system of claim 79, wherein the programming signal is received from a stand alone device capable of transmitting programming recorded on a data storage medium selected from the group consisting of: compact discs, digital versatile discs, video tape, gaming cartridges, memory sticks, magnetic storage mediums, optical storage mediums, random access memory, Flash memory, and read only memory.

84. The system of claim 79, wherein the media object is received in a format selected from the group consisting of: MPEG-1, MPEG-2, MPEG-4, MPEG-7, JPEG, motion JPEG, GIFs, QuickTime, ActiveMovie, DVI, and Indeo.

85. The system of claim 80, wherein the programming signal is received as a streamed signal.

86. The system of claim 79, wherein the programming signal includes a media object containing content in a form selected from the group consisting of: news program, sports program, entertainment program, music video, game show program, motion picture program, video program, live program, audio program, non-commercial program, polling question, and a pre-recorded program.

87. The system of claim 79, wherein the programming signal includes a media object containing advertising related content.

88. The system of claim 79, further comprising:
a user profiling system, in communication with the receiving system, providing at least one user profile associated with the user;
whereupon receiving a media object, the receiving system obtains a user profile associated with the user from the user profiling system, determines whether a user profile targeted by the media object and a users profile associated with the user match, and based upon the determination directs the presentation system to present the media object to the user when a match occurs and to not present the media object when a match does not occur.

89. The system of claim 88, wherein the user profiling system generates at least two profiles wherein the first user profile is associated with an adult audience and the second user profile is associated with an adolescent audience.

90. The system of claim 88, wherein the user profiling system generates a user profile based upon at least one source selected from the group consisting of: a response by a user to a survey, demographic information, user viewing habits, selections of media objects by a user during a programming signal, a compilation of viewing habits of more than one user, user purchase behavior, statistical information, and regional information.

91. The system of claim 79, wherein the system further comprises a user input device, in communication with the receiving system, for selecting at least one media object received in the programming signal.

92. The system of claim 91, wherein the user input device further comprises at least one device selected from the group consisting of: a remote control, keyboard, scanner, mouse trackball, virtual reality sensor, voice recognition system, voice verification system, push button, touch screen, and joy stick.

93. The system of claim 79, wherein the system further comprises a data storage device, in communication with the receiving system, for storing at least one media object, wherein the data storage device is accessed via a network selected from the group consisting of: Internet, intranet, private network, wired network, ATM network, wireless network, wide area network, local area network, and a public network.

94. The system of claim 93, wherein the data storage device utilizes at least one data storage medium selected from the group consisting of: compact disc, digital versatile disc, video tape, game cartridge, memory stick, magnetic storage medium, optical storage medium, random access memory, Flash memory, and read only memory.

95. The system of claim 79, wherein the receiving system further comprises:
a transceiver, for receiving the programming signal from a transmitting system;
at least one demultiplexer, connected to the transceiver, which selects from the programming signal at least one media object containing content targeted to a user profile;
a buffer, connected to the demultiplexer, for storing the media object selected by the demultiplexer;
a decompressor, connected to the demultiplexer and the buffer, which decompresses the media object and outputs a decompressed media object;
a composition generator, connected to the decompressor, which receives at least one decompressed media object and composes the received media object into a composite signal; and
a controller, connected to the transceiver, the buffer, the decompressor, and the composition generator, which controls the operation of the receiving system, further comprising a timing and synchronization unit which provides timing and synchronization signals to each of the transceiver, the demultiplexer, the buffer, the decompressor, and the composition generator, and synchronizes the spatial and temporal relationships of at least two media objects provided in the programming signal.

96. A system for presenting a media object containing content targeted to a user profile comprising:
a receiving system further comprising:
a transceiver, for receiving a programming signal from a transmitting system, wherein the programming signal contains at least one media object containing content targeted to a first user profile;
at least one demultiplexer, connected to the transceiver, which selects from the programming signal at least one media object;
a buffer, connected to the demultiplexer, for storing the media object selected by the demultiplexer;
a decompressor, connected to the demultiplexer and the buffer, which decompresses the media object;
a composition generator, connected to the decompressor, which composes the decompressed media object into a composite signal; and
a controller, connected to the transceiver, the buffer, the decompressor, and the composition generator, which controls the operation of the receiving system;
a presentation system, in communications with the receiving system, which receives the composite signal and presents the composite signal to the user;
a user profiling system, in communication with the receiving system, providing a second user profile associated with the user;
a user input device, in communication with the receiver, for selecting a programming signal; and
a data storage device, in communication with the receiving system, for storing at least one media object;
whereupon a user selecting a programming signal containing at least one media object, the receiving system queries the user profiling system to determine whether the second user profile matches the first user profile, and when a match occurs, the receiving system retrieves the media object from the programming signal, decompresses the media object, composes the media object into a composite signal, and outputs the composite signal to the presentation system.

97. The system of claim 96, wherein the system is provided in a device selected from the group consisting of: television, home theater system, computer workstation, video presentation device, personal data assistant, virtual reality system, audio reproduction system, telephonic system, gaming console, tactile signal generating device, cable box, and set top box.

98. The system of claim 96, wherein the programming signal utilizes a format selected from the group consisting of: MPEG-1, MPEG-2, MPEG-4, MPEG-7, JPEG, motion JPEG, GIFs, QuickTime, ActiveMovie, DVI, and Indeo.

99. The system of claim 96, wherein the programming signal includes media object based content in a form selected from the group consisting of: news program, sports program, entertainment program, music video, game show program, motion picture program, video program, live program, audio program, non-commercial program, educational program, and a pre-recorded program.

100. The system of claim 96, wherein the programming signal includes media object based advertising related content.

101. The system of claim 96, wherein the user profiling system generates a user profile based upon at least one source selected from the group consisting of: a response to a survey by a user, demographic information, user viewing habits, selections of media objects by a user during a programming signal, a compilation of viewing habits of more than one user, user purchase behavior, statistical information, and regional information.

102. The system of claim 96, wherein the receiving system further comprises a chat interface, connected to the receiving system, wherein at least one media object is utilized to facilitate communications via the chat interface.

103. The system of claim 96, wherein the receiving system further comprises an electronic mail interface, connected to the receiving system, wherein the electronic mail interface utilizes at least one media object to facilitate communications.

104. A system for presenting a media object containing content targeted to a user profile comprising:
a means for receiving a programming signal containing a media object, wherein the media object contains content targeted to a user profile;
a means for identifying a user associated with the user profile targeted by the media object;
a means for extracting the media object from the programming signal; and
a means for presenting the extracted media object to a user associated with the user profile;
whereupon receiving a programming signal containing at least one media object containing content targeted to a user profile, the system associates a user with the user profile, extracts the media object targeted to the user profile from the programming signal, and presents the media objects to the user associated with the user profile.

105. The system of claim 104, wherein the system is provided in a device selected from the group consisting of: television, home theater system, computer workstation, video presentation device, personal data assistant, virtual reality system, gaming console, audio presentation device, telephonic system, and set top box.

106. The system of claim 104, wherein the media object includes content in a form selected from the group consisting of: news program, sports program, entertainment program, music video, game show program, motion picture program, video program, live program, audio program, non-commercial program, educational program, and a pre-recorded program.

107. The system of claim 104, wherein the media object includes advertising related content.

108. The system of claim 104, wherein the programming signal is in a format selected from the group consisting of: MPEG-1, MPEG-2, MPEG-4, MPEG-7, JPEG, motion JPEG, GIFs, QuickTime, ActiveMovie, DVI, and Indeo.

109. The system of claim 104, wherein the system further comprises a means for engaging in chat, wherein at least one media object is utilized to facilitate communications via the chat means.

110. The system of claim 104, wherein the system further comprises an electronic mail means, wherein at least one media object is utilized to facilitate communications via the electronic mail means.

111. The system of claim 104, wherein the system further comprises an instant messaging means, wherein at least one media object is utilized to facilitate communications via the instant messaging means.

112. The system of claim 104, wherein the programming signal is received from a stand alone device capable of transmitting programming recorded on a data storage medium selected from the group consisting of: compact disc, digital versatile disc, video tape, gaming cartridge, memory stick, magnetic storage medium, optical storage medium, random access memory, Flash memory, and read only memory.

113. A method for presenting a media object containing content targeted to a user profile comprising:
receiving a programming signal containing at least one media object containing content targeted to a user profile;
identifying a user associated with the user profile;
selecting a media object in the programming signal based upon the user profile;
composing the selected media object into a composite signal; and
presenting the composite signal to a user associated with the user profile.

114. The method of claim 113, wherein the programming signal is received via a transmission medium selected from the group consisting of: broadcast, wireless, wireline, microwave, millimeter wave, satellite, cable, and fiber optics.

115. The method of claim 113, wherein the programming signal is received from a stand alone device capable of transmitting programming recorded on a data storage medium selected from the group consisting of: compact disc, digital versatile disc, video tape, gaming cartridge, memory stick, magnetic storage medium, optical storage medium, random access memory, Flash memory, and read only memory.

116. The method of claim 113, wherein the method is implemented, at least in part, in a device selected from the group consisting of: television, home theater system, computer workstation, video presentation device, personal data assistant, virtual reality system, audio presentation system, gaming console, telephonic system, and set top box.

117. The method of claim 113, wherein the composite signal further comprises at least one signal selected from the group consisting of: a video signal, an audio signal, a combined audio and video signal, animation, text, graphics, multimedia, slow frame video, video stills, sequences of individual frames, virtual reality, live, pre-recorded, natural, synthetic, combined natural and synthetic, and computer generated signals.

118. The method of claim 113, wherein the programming signal includes media object content in a form selected from the group consisting of: news program, sports program, entertainment program, music video, game show program, motion picture program, video program, live program, audio program, non-commercial program, educational program, and a pre-recorded program.

119. The method of claim 113, wherein the programming signal includes advertising related media object content.

120. The method of claim 113, wherein the method further comprises the step of generating the user profile based upon at least one source selected from the group consisting of: a response by a user to a survey, demographic information, user viewing habits, selections of media objects by a user during a programming signal, a compilation of viewing habits of more than one user, user purchase behavior, statistical information, and regional information.

121. A method for presenting a media object containing content targeted to a user profile comprising:
receiving a programming signal, wherein the programming signal comprises at least one media object containing content targeted to a user profile;
identifying a user associated with the user profile;
selecting at least one media object from the programming signal based upon the user profile; and
presenting the media object to the user.

122. The method of claim 121, wherein the method further comprises storing the media object selected from the programming signal in a buffer until a designated time for presentation of the media object to the user occurs.

123. The method of claim 121, wherein the media object is provided in a compressed format and the method further comprises decompressing the media object before presenting the media object to a user.

124. The method of claim 121, wherein the step of presenting the media object to a user further comprises composing the media object selected from the programming signal and a second media object into a composite signal and presenting the composite signal to a user associated with the user profile.

125. The method of claim 121, wherein the method further comprises receiving an input from a user input device, wherein the input provides a viewing choice for the user related to at least one option selected from the group consisting of: a channel selection, a media object selection, and a user identification.

126. The method of claim 122, wherein the user input device includes at least one device selected from the group consisting of: a remote control, keyboard, scanner, mouse, trackball, virtual reality sensor, voice recognition system, voice verification system, push button, touch screen, and joy stick.

127. The method of claim 121, wherein the method is implemented via at least one device selected from the group consisting of: television, home theater system, computer workstation, video presentation device, personal data assistant, virtual reality system, audio presentation system, telephonic system, gaming console, and set top box.

128. The method of claim 121, wherein the programming signal is received via a transmission medium selected from the group consisting of: broadcast, wireless, wireline, microwave, millimeter wave, satellite, cable, and fiber optics.

129. The method of claim 121, wherein the programming signal further comprises at least one signal selected from the group consisting of: a video signal, an audio signal, a combined audio and video signal, animation, text, graphics, multimedia, slow frame video, video stills, sequences of individual frames, virtual reality, live, pre-recorded, natural, synthetic, combined natural and synthetic, and computer generated signals.

130. The method of claim 121, wherein the programming signal is received from a stand alone device capable of transmitting programming recorded on a data storage medium selected from the group consisting of: compact disc, digital versatile disc, video tape, gaming cartridge, memory stick, magnetic storage medium, optical storage medium, random access memory, Flash memory, and read only memory.

131. The method of claim 121, wherein the programming signal utilizes a format selected from the group consisting of: MPEG-1, MPEG-2, MPEG-4, MPEG-7, JPEG, motion JPEG, GIFs, QuickTime, ActiveMovie, DVI, and Indeo.

132. The method of claim 121, wherein the programming signal is streamed over a network connection.

133. The method of claim 121, wherein the programming signal includes media object content which relates to at least one program type selected from the group consisting of: news program, sports program, entertainment program, music video, game show program, motion picture program, video program, live program, audio program, non-commercial program, educational program, and a pre-recorded program.

134. The method of claim 121, wherein the programming signal includes a media object, which relates to advertising content.

135. The method of claim 121, wherein the method further comprises generating a user profile based upon information selected from the group consisting of: a response by a user to a survey, demographic information, user viewing habits, selection of a media object by a user during a programming signal, a compilation of viewing habits of more than one user, user purchase behavior, statistical information, and regional information.

136. The method of claim 121, wherein the step of generating a user profile is accomplished by at least one system selected from the group consisting of: a receiving system, a transmitting system, and a media object creator.

137. The method of claim 121, wherein the user profile is obtained from the remote data storage device via a network selected from the group consisting of: Internet, intranet, private network, wired network, ATM network, wireless network, wide area network, local area network, and a public network.

138. The method of claim 121, wherein the method further comprises:
pushing additional media objects to a user, wherein the additional media objects relate to at least one media object extracted from the programming signal.

139. A computer readable medium containing instructions for presenting a media object containing content targeted to a user profile, by:
receiving a programming signal, wherein the programming signal comprises at least one media object containing content targeted to a user profile;
identifying a user associated with the user profile;
extracting at least one media object from the programming signal based upon the user profile; and
presenting the media object to the user.

140. The computer readable medium of claim 139, wherein the programming signal is received from a stand-alone device capable of transmitting programming recorded on a data storage medium selected from the group consisting of: compact disc, digital versatile disc, video tape, gaming cartridge, memory stick, magnetic storage medium, optical storage medium, random access memory, Flash memory, and read only memory.

141. The computer readable medium of claim 139, wherein the computer readable medium is utilized in conjunction with a device selected from the group consisting of: television, home theater system, computer workstation, video presentation device, personal data assistant, virtual reality system, audio presentation system, gaming console, telephonic system, and set top box.

142. The computer readable medium of claim 139, wherein the media object further comprises at least one signal in a form selected from the group consisting of: a video signal, an audio signal, a combined audio and video signal, animation, text, graphics, multimedia, slow frame video, video stills, sequences of individual frames, virtual reality, live, prerecorded, natural, synthetic, combined natural and synthetic, and computer generated signals.

143. The computer readable medium of claim 139, wherein the media object includes content in a form selected from the group consisting of: news program, sports program, entertainment program, music video, game show program, motion picture program, video program, live program, audio program, non-commercial program, educational program, and a pre-recorded program.

144. The computer readable medium of claim 139, wherein the media object includes advertising related content.

145. The computer readable medium of claim 139, wherein the instructions further provide for storing the extracted media object in a buffer until a designated time for presentation to the user occurs.

146. The computer readable medium of claim 139, wherein the programming signal utilizes a format selected from the group consisting of: MPEG-1, MPEG-2, MPEG-4, MPEG-7, JPEG, motion JPEG, GIFs, QuickTime, ActiveMovie, DVI, and Indeo.

147. The computer readable medium of claim 139, wherein the programming signal is streamed over a network selected from the group consisting of: Internet, intranet, private network, wired network, ATM network, wireless network, wide area network, local area network, and a public network.

148. The computer readable medium of claim 139, wherein the instructions further provide for generating a user profile based upon information selected from the group consisting of: a response by a user to a survey, demographic information, user viewing habits, selection of a media object by a user during a programming signal, a compilation of viewing habits of more than one user, user purchase behavior, statistical information, and regional information.

149. A system for generating a user profile based upon a selection by a user of a media object providing content targeted to a user profile, wherein the media object is included in a programming signal comprising:
a receiving system for receiving at least two media objects in a programming signal, wherein each media object provides content targeted to a user profile;
a presentation system, connected to the receiving system, for presenting the at least two media objects to the user;
a user input device for selecting one of the at least two media objects presented;
a data storage device for recording each user selection; and
a user profiling system for generating a user profile based upon a collection of user selections of media objects presented to the user;
wherein the user profile is utilized in subsequent programming signals to determine which media objects to include in the programming signal and present to the user.

150. The system of claim 149, wherein the user profiling system generates a user profile based upon at least one source selected from the group consisting of: a response by a user to a survey, demographic information, user viewing habits, selections of media objects by a user during a programming signal, a compilation of viewing habits of more than one user, user purchase behavior, statistical information, and regional information.

151. The system of claim 149, wherein the user profiling system is located with a system transmitting the programming signal.

152. The system of claim 149, wherein the user profiling system is located with a system generating the media objects provided in the programming signal.

153. The system of claim 149, wherein the user profiling system is located with the receiving system.

154. The system of claim 149, wherein the user profiling system is accessed via a network selected from the group consisting of: Internet, intranet, private network, wired network, ATM network, wireless network, wide area network, local area network, and a public network.

155. The system of claim 149, wherein the system further comprises a user input device for selecting at least one media object received in the programming signal, wherein the selection is utilized to generate the user profile.

156. The system of claim 155, wherein the user input device further comprises at least one device selected from the group consisting of: a remote control, keyboard, scanner, mouse, trackball, virtual reality sensor, voice recognition system, voice verification system, push button, touch screen, and joy stick.

157. A method for generating a user profile based upon media objects containing content targeted to a user profile, wherein the media objects are provided in a programming signal and selected by a user, comprising:
receiving a programming signal containing at least two media objects, wherein each media object contains content targeted to a user profile;
presenting the programming signal to a user;
receiving a response from the user, wherein the response indicates a user's selection of at least one of the at least two media objects provided in the programming signal; and
generating a user profile based upon the user response.

158. The method of claim 157, wherein the method further comprises saving each response from the user in a data storage device and generating the user profile based upon a collection of responses stored in the data storage device.

159. The method of claim 158, wherein the user profile is generated based upon data obtained from at least one source selected from the group consisting of: a response by a user to a survey, demographic information, user viewing habits, selections of media objects by a user during a programming signal, a compilation of viewing habits of more than one user, user purchase behavior, statistical information, and regional information.

160. The method of claim 158, wherein the data storage device is located with at least one system selected from the group consisting of: a system which transmits the programming signal, a system which generates the media objects, and a system which receives the programming signal.

161. The method of claim 158, wherein the data storage device further comprises a Web site accessible via a network selected from the group consisting of: Internet, intranet, private network, wired network, ATM network, wireless network, wide area network, local area network, and a public network.

162. A method for pushing a media object containing content targeted to a user profile comprising:
obtaining a user profile for a user;
receiving a programming signal selection from the user, wherein the programming signal selection designates a specific programming signal the user desires to receive;
transmitting at least one media object in the selected programming signal to the user, wherein the media object is pushed to the user based upon the user profile;
extracting a media object from the programming signal; and
presenting the extracted media object to the user;
wherein content targeted to the user is pushed to the user via the extracted media object.

163. The method of claim 162, wherein the step of obtaining a user profile for a user is accomplished by a user profiling system provided in at least one system selected from the group consisting of: a transmitting system, a receiving system, a media object creating system, and an user profiling system.

164. The method of claim 163, wherein the user profiling system further comprises a Web site accessible via a network selected from the group consisting of: Internet, intranet, private network, wired network, ATM network, wireless network, wide area network, local area network, and a public network.

165. The method of claim 162, wherein the step of obtaining a user profile for a user further comprises generating a user profile based upon information selected from the group consisting of: a response by a user to a survey, demographic information, user viewing habits, selection of a media object by a user during a programming signal, a compilation of viewing habits of more than one user, user purchase behavior, statistical information, and regional information.

166. The method of claim 162, wherein the step of receiving a programming signal selection from a user is accomplished via at least one user input device selected from the group consisting of: a remote control, keyboard, scanner, mouse, trackball, virtual reality sensor, voice recognition system, voice verification system, push button, touch screen, and joy stick.

167. The method of claim 166, whereupon receiving the programming signal selection, the method further comprises the step of inserting at least one media object into the programming signal; wherein the media object is targeted to be presented to the user during specific instances in a programming signal selected by the user.

168. The method of claim 162, wherein the programming signal selection is communicated to the receiving system and the method further comprises:
accessing at least one profiling rule, wherein the profiling rule designates which media objects to select in a given programming signal for a given user profile; and
correlating the selected programming signal, the user profile, and the profiling rule in determining which media object in the programming signal to select for presentation to the user.

169. The method of claim 168, wherein the profiling rule is obtained from the transmitting system via at least one communications medium selected from the group consisting of: cable, coaxial cable, twisted pair cable, fiber-optic cable, telephone cable, closed circuit cable, satellite broadcast, radio frequency broadcast, and a wireless medium.

170. The method of claim 162, wherein the media object includes content in a form selected from the group consisting of: news program, sports program, virtual reality program, entertainment program, music video, game show program, motion picture program, video program, live program, audio program, polling question, non-commercial program, educational program, and a pre-recorded program.

171. The method of claim 162, wherein the media object includes advertising related content.

172. The method of claim 162, wherein the programming signal further comprises a signal containing at least one media object providing content in a form selected from the group consisting of: a video signal, an audio signal, a combined audio and video signal, animation, text, graphics, multimedia, slow frame video, video stills, sequence of individual frames, virtual reality, live, pre-recorded, natural, synthetic, combined natural and synthetic, and computer generated content.

173. The method of claim 162, wherein the step of obtaining a user profile for a user further comprises receiving a designation of the user profile from the user.

174. The method claim 173, wherein the designation of the user profile utilized by a receiving system to determine which of a plurality of media objects to extract from the programming signal.

175. The method of claim 174, wherein the receiving system filters out of the programming signal those media objects that are not associated with the user designated profile.

176. The method of claim 162, wherein the method further comprises synchronizing a first media object.

177. The method of claim 176, wherein the first media object comprises a video signal and the second media object comprises an audio signal.

178. A method for pulling a media object containing content targeted to a user comprising:
presenting a programming signal to a user, wherein the programming signal contains at least one media object containing content targeted to a user profile;
selecting a media object presented in the programming signal;
modifying the programming signal to reflect the selection of the media object; and
presenting a modified programming signal, wherein the modified programming signal includes at least one media object containing content targeted to the user profile.

179. The method of claim 178, wherein the method further comprises recording a selection of a media object by the user.

180. The method of claim 179, wherein the method further comprises generating a user profile based upon the recorded selection of a media object.

181. The method of claim 180, wherein a transmitting system utilizes the user profile in transmitting at least one media object targeted to the user.

182. The method of claim 180, wherein a media object creator utilizes the user profile in creating at least one media object targeted to the user.

183. The method of claim 178, wherein the programming signal is presented to the user via at least one device selected from the group consisting of: television, home theater system, computer workstation, video presentation device, personal data assistant, virtual reality system, audio presentation system, gaming console, telephonic system, and set top box.

184. The method of claim 178, wherein the method further comprises receiving the programming signal via transmission medium selected from the group consisting of: broadcast, wireless, wireline, microwave, millimeter wave, satellite, cable, and fiber optics.

185. The method of claim 178, wherein the method further comprises receiving the programming signal from a stand-alone device capable of transmitting programming recorded on a data storage medium selected from the group consisting of: compact disc, digital versatile disc, video tape, gaming cartridge, memory stick, magnetic storage medium, optical storage medium, random access memory, Flash memory, and read only memory.

186. The method of claim 178, wherein the programming signal utilizes a format selected from the group consisting of: MPEG-1, MPEG-2, MPEG-4, MPEG-7, JPEG, motion JPEG, GIFs, QuickTime, ActiveMovie, DVI, and Indeo.

187. The method of claim 178, wherein the media object further comprises at least one signal in a form selected from the group consisting of: video signal, audio signal, combined audio and video signal, animation, text, graphics, multimedia, slow frame video, video stills, sequence of individual frames, virtual reality, live, pre-recorded, natural, synthetic, combined natural and synthetic, and computer generated signals.

188. The method of claim 178, wherein the media object includes content in a form selected from the group consisting of: news program, sports program, entertainment program, music video, game show program, motion picture program, video program, live program, audio program, non-commercial program, educational program, advertising, and a pre-recorded program.

189. The method of claim 178, wherein the step of selecting a media object presented in the programming signal is accomplished utilizing a user input device selected from the group consisting of: a remote control, keyboard, scanner, mouse, trackball, virtual reality sensor, voice recognition system, voice verification system, push button, touch screen, and joy stick.

190. The method of claim 180, wherein the step of generating a user profile further comprises utilizing user profile information selected from the group consisting of: prior recordings of user selections, response by the user to a survey, demographic information, user viewing habits, a compilation of viewing habits of more than one user, user purchase behavior, statistical information, and regional information.

191. The method of claim 178, wherein the modified programming signal is presented to the user via at least one device selected from the group consisting of: television, home theater system, computer workstation, video presentation device, personal data assistant, virtual reality system, audio presentation system, gaming console, telephonic system, and set top box.

192. The method of claim 178, wherein the step of modifying the programming signal to reflect the selection of a media object further comprises:
communicating the selection of the media object to a transmitting system;
selecting a second media object provided by at least one media object creator to the transmitting system; and
transmitting the second media object to a receiving system for presentation to the user; wherein the second media object includes content related to the selected media object.

193. The method of claim 178, wherein the step of modifying the programming signal to reflect the selection of a media object further comprises:
communicating the selection of the media object to a media object creator;
creating a second media object containing content related to the selected media object and targeted to the user;
incorporating the second media object into the modified programming signal; and
transmitting the modified programming signal, via a transmitting system, to a receiving system for presentation to the user.

194. The method of claim 193, wherein the method further comprises synchronizing the presentation of the selected media object and the second media object in the modified programming signal.
